(19) United States
(12) Patent Application Publication
(10) Pub. No.: US 2007/0024851 A1
(43) Pub. Date: Feb. 1, 2007

(54) Method and smart device to determine the substrate optical constant and the film thickness of absorbing-film-absorbing-substrate systems in an absorbing medium using a closed-form formula and reflection ellipsometry

(76) Inventors: Mervat A. Zaghloul, Pooler, GA (US); A R M. Zaghloul, Pooler, GA (US); Yasser A. Zaghloul, Pooler, GA (US)

Correspondence Address: YASSER A. ZAGHLOUL, 2926 OSPREY POINT CIRCLE, POOLER, GA, 31322, US

(21) Appl. No.: 11/459,355

(22) Filed: Jul. 23, 2006

Related U.S. Application Data
(60) Provisional application No. 60/595,693, filed on Jul. 28, 2005.

(51) Int. Cl. G01J 4/00

(52) U.S. Cl. 356/369

(57) ABSTRACT

Seven methods to dynamically characterize in real-time the substrate of absorbing-film absorbing-substrate systems in an absorbing mediums: determine the substrate optical constant or the substrate optical constant and film thickness, depending on the method, using an ellipsometer to measure one or two pairs of the two ellipsometric angles psi and del at one or two angles of incidence and at only one wavelength, and the known film optical constant or film optical constant and film thickness, are provided. Also, seven corresponding methods to design reflection-type film-substrate optical polarization devices: determine the substrate optical constant or the optical constant and film thickness of a film-substrate system to perform as a pre-specified optical polarization device at pre-specified conditions. A software program and/or a smart device to be a part of any ellipsometer or ellipsometer system, or to be added to any existing ellipsometer or ellipsometer system, are also provided.

### CROSS-REFERENCE TO RELATED APPLICATIONS

This is a non-provisional application claiming the priority of Provisional Application No. 60/595,693 filed on Jul. 28, 2005.

### FIELD OF INVENTION

The present invention relates to a real-time dynamic substrate characterization of a film-substrate system using a closed-form formula and ellipsometric measurements; and more particularly, to a real-time dynamic determination of the optical constant of the substrate and the film thickness of a film-substrate system using reflection ellipsometric measurements on the system and an algebraically-derived closed-form formula.

### BACKGROUND OF THE INVENTION

Ellipsometry is an optical technique that is widely used to characterize film-substrate systems by measuring the two ellipsometric angles psi and del at a certain angle of incidence and a certain wavelength. There are many ellipsometric techniques to do the measurements, and new ones are being developed all the time. A mathematical model developed in the 19^{th} century is used to obtain the optical constants of the film and the substrate in addition to the film thickness. In that model, each measured pair of psi and del provides one complex equation that is equivalent to two real equations. The widespread methods to determine the optical constants and film thickness require a number of real equations equal to the number of unknowns to be determined. Therefore, five real equations are required to determine the optical constants and film thickness since each optical constant is a complex number which has a real and an imaginary component. That requires three pairs of the angles psi and del measured at either three different angles of incidence (Multiple-Angle-Of-lncidence Ellipsometry) or at three different wavelengths (Spectroscopic Ellipsometry.) Several numerical techniques exist today to obtain the required results from the multiple measurements. All take desperately needed time and computational power for dynamic real-time applications. Some require continued intervention by and interaction with a human operator as many of the programs provided by ellipsometer manufacturers today.

Algebraic solution to the ellipsometric equation governing the complex model of the film-substrate system to provide a closed-form formula to calculate the optical constant of the substrate is a very difficult and involved task. Previous to this invention, an analytic method was developed to find a polynomial in the optical constant of the substrate which is solved using numerical methods. No closed-form for the optical constant of the substrate is ever derived before. Some of the advantages of a closed-form formula over numerical methods are: 1) it does not require a close-to-the-unknown-solution starting value for the unknown parameter, 2) it involves no repeated calculations, only one, 3) it does not ever diverge giving no solution, 4) it does not get trapped in a false solution, 5) it does not get trapped in a local incorrect solution, 6) it has no merit function to minimize, 7) it does not involve numerical calculations of the derivative of the function, 8) its speed does not depend on the topology of the function, 9) its speed does not depend on the choice of the merit function, 10) its speed does not depend on the choice of the starting solution, 11) it does not require any involvement of, or interaction with, the user.

On the other hand, there exist several analytical methods to obtain some of the system parameters from measured values. None has a closed form given as we mentioned before. They all provide the methodology and derivation of polynomial equation(s) and stop short of providing a closed form solution. Derivations are only provided for special cases, such as nonabsorbing-films on nonabsorbing-substrates at a special angle of incidence, unsupported nonabsorbing uniform layer, actually numerical and not an analytical method regardless of the title, approximate solution for the substrate refractive index in the presence of an ultrathin layer, and for film thickness determination from the film-thickness exponential function, as is already well known.

### SUMMARY OF THE INVENTION

It is, therefore, an object of the present invention to provide a real-time dynamic method by providing an algebraically derived closed-form formula to calculate the optical constant of the substrate. The provided closed-form formula gives the correct results in each and every case.

An object of the invention is to dynamically characterize in real-time the substrate of an absorbing-film absorbing-substrate system in an absorbing medium: determine the substrate optical constant by direct substitution into a given closed-form formula using any ellipsometer to measure only one pair of the two ellipsometric angles psi and del at only one angle of incidence and at only one wavelength, and the known film parameters of thickness and optical constant.

Another object of the invention is to dynamically characterize in real-time the substrate of an absorbing-film absorbing-substrate system in an absorbing medium: determine the substrate optical constant by direct substitution into a given closed-form formula using any ellipsometer to measure only two pairs of the two ellipsometric angles psi and del at only two angles of incidence and at only one wavelength, and the known film parameters of thickness and optical constant.

Another object of the invention is to dynamically characterize in real-time the substrate of an absorbing-film absorbing-substrate system in an absorbing medium: determine the substrate optical constant by direct substitution into a given closed-form formula using any ellipsometer to measure only three pairs of the two ellipsometric angles psi and del at only three angles of incidence and at only one wavelength, and the known film parameters of thickness and optical constant.

Another object of the invention is to dynamically characterize in real-time the substrate of an absorbing-film absorbing-substrate system in an absorbing medium: determine the substrate optical constant by direct substitution into a given closed-form formula using any ellipsometer to measure only two pairs of the two ellipsometric angles psi and del at only two film thicknesses of the same film material at only one angle of incidence and at only one wavelength, and the known film parameters of thickness and optical constant.

Another object of the invention is to dynamically characterize in real-time the substrate of an absorbing-film absorbing-substrate system in an absorbing medium: determine the substrate optical constant by directly substituting into a given closed-form formula using any ellipsometer to measure only two pairs of the two ellipsometric angles psi and del at only one film thickness of two different film materials at only one angle of incidence and at only one wavelength, and the known film parameters of thickness and optical constant.

Another object of the invention is to dynamically characterize in real-time the substrate and to determine the thickness of the film of an absorbing-film absorbing-substrate system in an absorbing medium: determine the substrate optical constant and the film thickness by direct substitution into a given closed-form formula and by using a clearly outlined method using any ellipsometer to measure only two pairs of the two ellipsometric angles psi and del at only two angles of incidence and at only one wavelength and the only known film parameter of the optical constant.

Another object of the invention is to dynamically characterize in real-time an absorbing bare-substrate system in an absorbing medium: determine the bare-substrate optical constant by direct substitution into a given closed-form formula using any ellipsometer to measure only one pair of the two ellipsometric angles psi and del at only one angle of incidence and at only one wavelength.

Seven other objects of the invention that parallel the above seven are to design reflection-type optical polarization devices: determine the substrate optical constant or the substrate optical constant and film thickness of a film-substrate system to perform as a pre-specified optical polarization device at pre-specified conditions using given closed-form design formulae and clearly outlined methods.

Another object of the present invention is to provide a software computer program to do the same.

Another object of the present invention is to provide a smart device to do the same that can be used with any existing ellipsometer or ellipsometer system, or any ellipsometer or ellipsometer system to be manufactured.

As the different objects of the present invention that are only presented as preferred embodiments to illustrate the invention are clearly understood by professionals in the field as a result of this patent, it is expected that the other applications of the closed-form formulae and their associated methods will be identified.

### DESCRIPTION OF DRAWINGS

Referring to the drawing detail, FIG. 1 illustrates the film-substrate system. The substrate has an optical constant of N₂with an overlaid film of an optical constant of N₁, both at the used wavelength, and a film thickness of d. The electromagnetic wave falls on the surface of the system at an angle of incidence of φ₀, and is reflected at the same angle. When the ellipsometric measurements are made on the incident and reflected beams, it is reflection ellipsometry. When the ellipsometric measurements are made on the incident and transmitted (not shown in figure) waves it is transmission ellipsometry. In practice, we are not interested in the ellipsometric measurements themselves. We are interested in determining the optical constants of the film and the substrate and the film thickness from those measurements. This film-substrate system acts as a polarization device that produces any required polarization changes into the incident waves upon reflection, or transmission.

FIG. 2 is an illustration of a system realization. L is a laser source that produces circularly polarized light at a specific wavelength, P is an optical polarizer that passes a linearly polarized light, S is the sample which in this case is a film-substrate system, D is our Real Time Smart Detector. This smart detector includes a photodetector and our claimed instrument that does the analysis and provides the needed optical constant of the substrate and the film thickness as outputs. This configuration is a Single-Element Rotating-Polarizer ellipsometer configuration. Any ellipsometer configuration can be used with our Real Time Smart Detector.

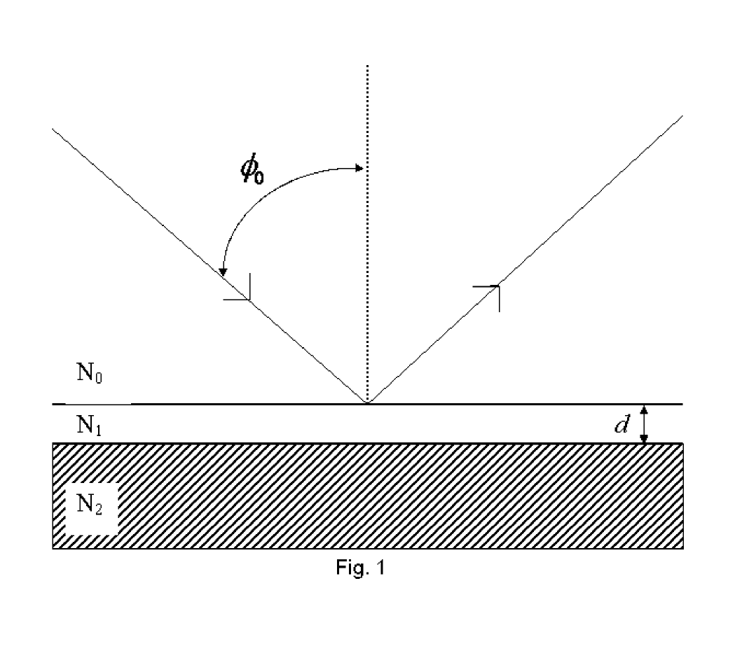

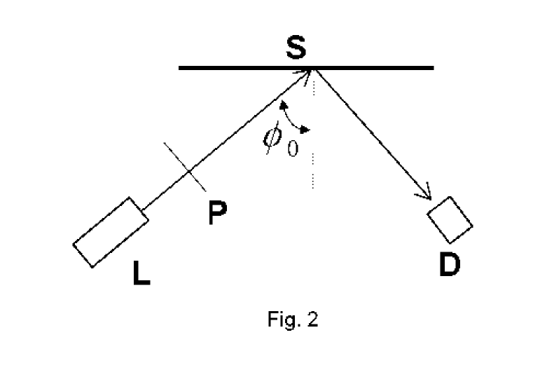

### DETAILED DESCRIPTION OF THE INVENTION

We present a closed-form formula that is algebraically derived to determine the substrate optical constant, complex refractive-index, and methodologies employing that formula to:

1. Determine the optical constant, complex refractive-index, of the substrate.

2. Determine the optical constant of the substrate and the film thickness.

We present a closed-form inversion expression to obtain the optical constant (complex refractive-index) of the substrate of a film-substrate system from one measurement of reflection ellipsometry. It requires the prior knowledge of the optical constant of the film and its thickness. If only the optical constant is known, which is a more practical case, a second measurement at, for example, a second angle of incidence is required. In this case the film thickness, in addition to the substrate optical constant, is determined. A second formula that is valid for two measurements at two angles of incidence for the same film-substrate system, at two film-substrate systems with different thicknesses, and at two film-substrate systems with different film materials. A third closed-form formula for three angles of incidence is also presented. The formulae derived are valid for the general case of an absorbing-film on an absorbing-substrate system in an absorbing medium. They do not introduce errors themselves, and very well tolerate errors in input variables. Random and systematic errors in the input parameters do not affect the obtained value for the optical constant of the substrate. It is always the exact true value to three decimals. This is the conclusion of an exhaustive study of the effects of input errors on the obtained results. The bare-substrate system is considered as a special case, and a closed-form formula is obtained. Two examples in ellipsometry and the design of reflection-type optical devices are presented and discussed in Sec. 4. In Sec. 5, some experimental results on a commercially available wafer are also presented proving the applicability of the derived expression.

2. Ellipsometric Function

The film-substrate system under consideration is composed of a single absorbing-film on an absorbing-substrate, where N₀, N₁, and N₂ are the optical constants (complex refractive indices) of the ambient, film, and substrate, respectively. d is the film thickness, φ₀ is the angle of incidence, and λ is the wavelength of the light source used. The system is assumed to be homogenous, isotropic, and semi-infinite.

The ellipsometric function ρ that relates the polarization properties of the reflected wave to that of the incident one is given by the ratio of the complex amplitude reflection coefficients for the p (parallel to the plane of incidence) and s (perpendicular) components of the electric vector representing the electromagnetic wave(s), Rₚ and Rₛ, respectively.

$$\begin{matrix}ρ = {R}_{p} / {R}_{s} , & ( 1 ) \\ {R}_{p} = \frac{{r}_{01 p} + {r}_{12 p} X}{1 + {r}_{01 p} {r}_{12 p} X} , & ( 2 ) \\ {R}_{S} = \frac{{r}_{01 S} + {r}_{12 S} X}{1 + {r}_{01 S} {r}_{12 S} X} , & ( 3 )\end{matrix}$$

where, r₀₁ₚ and r₀₁ₛ (r₁₂ₚ and r₁₂ₛ) are the Fresnel reflection-coefficients governing the wave polarization properties upon reflection at the ambient-film (film-substrate) interface. They are given by,

$$\begin{matrix}{r}_{01 p} = \frac{{N}_{1} cos {ϕ}_{0} - {N}_{0} cos {ϕ}_{1}}{{N}_{1} cos {ϕ}_{0} + {N}_{0} cos {ϕ}_{1}} , & ( 4 ) \\ {r}_{01 s} = \frac{{N}_{0} cos {ϕ}_{0} - {N}_{1} cos {ϕ}_{1}}{{N}_{0} cos {ϕ}_{0} + {N}_{1} cos {ϕ}_{1}} , & ( 5 ) \\ {r}_{12 p} = \frac{{N}_{2} cos {ϕ}_{1} - {N}_{0} cos {ϕ}_{2}}{{N}_{2} cos {ϕ}_{1} + {N}_{0} cos {ϕ}_{2}} , & ( 6 ) \\ {r}_{12 s} = \frac{{N}_{1} cos {ϕ}_{1} - {N}_{2} cos {ϕ}_{2}}{{N}_{1} cos {ϕ}_{1} + {N}_{2} cos {ϕ}_{2}} , & ( 7 )\end{matrix}$$

and φ₀, φ₁, and φ₂ are the angles of incidence in the ambient, film, and substrate, respectively. These angles of incidence are related by Snell's law;
N₀ sin φ₀=N₂ sin φ₂. (8)

X, the complex thickness-exponential-function where the film thickness is isolated, is given by;²⁰
X=exp(−j4πdN₁ cos(φ₁)/λ). (9)
To better represent the periodic nature of the ellipsometric function as the film thickness d is changed, we put Eq(9) in the form,²⁰
X=exp(−j2πd/D_{φ),} (10)
where,
D_{φ}=λ/2N₁ cos φ₁, (11)
which is the film-thickness period, at which ρ reassumes the same value, and repeats its behavior with the film-thickness increase.²¹ Therefore, ρ is put in the form;²⁰

$$ρ = \frac{A + BX + {CX}^{2}}{D + EX + {FX}^{2}} , \qquad ( 12 )$$

where,
(A, B)=(r₀₁ₚ, r₁₂ₚ+r₀₁ₚr₀₁ₛr₁₂ₛ), (13.a)
(C, D)=(r₁₂ₚr₀₁ₛr₁₂ₛ, r₀₁ₛ), (13.b)
and,
(E, F)=(r₁₂ₛ+r₀₁ₚr₁₂ₚr₀₁ₛ, r₀₁ₚr₁₂ₚr₁₂ₛ). (13.c)

The ellipsometric function ρ is measured experimentally using ellipsometry. The instrument provides the experimental parameters ψ and Δ, where;
ρ=tan(ψ)·exp(jΔ). (14)
Here, tan ψ is the relative amplitude change in the incident wave upon reflection, and Δ is the relative phase shift.

At this point, we have the ellipsometric function ρ from both the physical model, Eq. (12), and experimentally, Eq. (14). An inversion procedure is now needed to provide the model parameters, N₀, N₁, N₂, and/or d, from the measured quantities ψ and Δ at one or more angles of incidence. Obviously, a closed form inversion is superior to a numerical, or iterative, one. It is accurate in itself and is very fast (direct substitution), where a solution always exists (no divergence), no false or local minima encountered, always stable, no prior knowledge of the solution (starting value(s)) required), no parameter range needed, no function to minimize, and no curve fitting techniques needed. It also provides for real-time applications. All these factors introduce errors by definition.

3. Closed-Form Inversion

To arrive at a closed-form inversion formula for calculating N using the measured values of the ellipsometric function ρ and the angle of incidence φ₀, we use several successive transformations. We spare the reader the details of algebraic manipulations and successive transformation involvement, and present a concise account of the derivation.

3. A. Single Angle of Incidence

We start with rewriting Eq. (12) in the form;

$$ρ = \frac{( {A}_{1} {N}_{2}^{2} + {A}_{2} {C}_{0} ) ( {B}_{3} {C}_{0} + {B}_{4} )}{( {A}_{3} {N}_{2}^{2} + {A}_{4} {C}_{0} ) ( {B}_{1} {C}_{0} + {B}_{2} )} , \qquad ( 15 )$$

where,
(A₀, B₀, C₀)=(N₀ sin φ₀, N₁ cos φ₁, N₂ cos φ₂), (16.a)
(A₁, B₁)=(B₀(r₀₁ₚ+X), r₀₁ₛ−X), (16.b)
(A₂, B₂)=(N₁²(r₀₁ₚ,−X), B₀(r₀₁ₛ+X)), (16.c)
(A₃, B₃)=(B₀(1+r₀₁ₚX), 1−r₀₁ₛX), (16.d)
and,
(A₄, B₄)=(N₁²(1−r₀₁ₚX), B₀(1+r₀₁ₛX)). (16.e)
Note that A₁−A₄ and B₁−B₄ depend only on A₀ and B₀; and on N₀, N₁, and φ₀, and not on C₀, which includes the unknown N₂.

Equation (15) is then rewritten in the form;

$${C}_{0}^{2} = ( \frac{{B}_{5}^{2} {N}_{2}^{4} + 2 {B}_{5} {B}_{6} {N}_{2}^{2} + {B}_{6}^{2}}{{A}_{5}^{2} {N}_{2}^{4} + 2 {A}_{5} {A}_{6} {N}_{2}^{2} + {A}_{6}^{2}} ) , \qquad ( 17 )$$

where,
(A₅, B₅)=(A₁B₃−ρA₃B₁, ρ(A₃B₂+A₄B₁)−(A₁B₄+A₂B₃)), (18.a)
and,
(A₆, B₆)=(A₂B₄−ρA₄B₂, A₀²(A₂B₃−ρA₄B₁)). (18.b)
Equation (17) is now rearranged into;
N₂⁶+A₇N₂⁴+A₈N₂²−A₉=0, (19)
where,

$$( {A}_{7} , {A}_{8} , {A}_{9} ) = ( \frac{2 {A}_{5} {A}_{6} - {A}_{0}^{2} {A}_{5}^{2} - {B}_{5}^{2}}{{A}_{5}^{2}} , \frac{{A}_{6}^{2} - {A}_{0}^{2} {A}_{5} {A}_{6} - 2 {B}_{5} {B}_{6 }}{{A}_{5}^{2}} , \frac{{A}_{0}^{2} {A}_{6}^{2} + {B}_{6}^{2}}{{A}_{5}^{2}} ) . \qquad ( 20 )$$

Equation (19) is a third-degree polynomial in N₂.

Note that A₅−A₉ and B₅−B₆ depend only on A₀ and B₀; on N₀, N₁ and φ₀; and on A_{1-A}₄ and B₁−B4, and not on C₀.

The closed-form solution of Eq. (19) is;

$$( {N}_{21} , {N}_{22} , {N}_{23} ) = ( \sqrt{{C}_{4} - \frac{{C}_{1}}{3 {C}_{4}} - \frac{{A}_{7}}{3}} , \sqrt{{C}_{5} - \frac{{C}_{1}}{3 {C}_{5}} - \frac{{A}_{7}}{3}} , \sqrt{{C}_{6} - \frac{{C}_{1}}{3 {C}_{6}} - \frac{{A}_{7}}{3}} ) , \qquad ( 21 )$$

where,

$$( {C}_{1} , {C}_{2} . {C}_{3} , {C}_{4} , {C}_{5} , {C}_{6} , {C}_{7} ) = ( {A}_{8} - \frac{{A}_{7}^{2}}{3} , - {A}_{9} - \frac{{A}_{7} {A}_{8}}{3} + \frac{2 {A}_{7}^{3}}{27} , - \frac{{C}_{2}}{2} + \sqrt{\frac{{C}_{2}^{2}}{4} + \frac{{C}_{1}^{3}}{27}} , \sqrt[3]{{C}_{3}} , {ⅇ}^{\frac{jπ}{1.5}} {C}_{4} , {ⅇ}^{\frac{jπ}{1.5}} {C}_{5} ) . \qquad ( 22 )$$

Note that we are considering only the positive values of the roots. Therefore, we only have three solutions to consider and not six.
3. A. 1. To Determine N₂ Only

The following algorithm shows how to use Eq. (21) to calculate the substrate complex refractive index N₂from the known values of the film complex refractive-index N₁ and thickness d, and of the experimental ellipsometric angles (φ₀, ψ, Δ).

Algorithm 1:
1. Calculate the values of A₁−A₉, B₁−B₆, and C₁−C₆ by direct substitution into Eqs. (14), (16) [excluding C₀], (18), (20), and (21) using the known values of the system parameters d and N₁, and the measured values of φ₀, ψ, and Δ. No other parameters are needed.
2. Calculate N₂ by direct substitution into Eq. (22).
3. The correct value of N₂ is that which satisfies the physical condition of positive refractive index (real part) and negative absorption coefficient (imaginary part.)
4. If more than one physically correct values of N₂ are obtained, a second set of ellipsometric angles (ψ′, Δ′) measured at a second angle of incidence φ₀′ is then needed to isolate the correct solution. In this case, Steps 1-3 are repeated and the common solution between the two sets is the correct one.

Note that the three steps of the algorithm are all direct calculations with no iterations involved.

3. A. 2. To Determine N₂ and d

To determine the complex refractive-index of the substrate and the film thickness, knowing only the film complex refractive-index, and not the film thickness, two ellipsometric measurements at two angles of incidence are required. In this case we have three real unknowns to determine; two for the optical constant and one for the film thickness. Mathematically, a measured ρ represents two real equations (one complex equation) that allow the determination of two real variables. The third requires one more equation, which is that at the second angle of incidence. In this case, the algorithm becomes;

Algorithm 2:
1. For an assumed value of the film thickness d calculate the values of A₁−A₉, B₁−B₆, and C₁−C₆ by direct substitution into Eqs. (14), (16) [excluding C₀], (18), (20), and (21) using the only known value of the system parameter N₁, and the measured ellipsometric values of (ψ₁, Δ₁) at the angle of incidence φ₀₁.
2. Calculate the solution set (N₂₁, N₂₂, N₂₃) by direct substitution into Eq. (22).
3. Repeat Steps 1 and 2 to obtain a second solution set at the second angle of incidence φ₀₂ using the second set of measurements (ψ₂, Δ₂) and the same assumed film thickness d used in Step 1.
4. Repeat Steps 1-3 for different film thickness values, to cover the range where the film thickness is expected, or from zero to a very large value of d if a range is not known.
5. Select the common solution between the two solution sets at the two angles of incidence, which is the correct one. It comes out to be physically correct by itself. No other selection criterion is needed. Note that a common solution at the two angles of incidence only exists at the correct value of the film thickness.
6. The values obtained for d and N₂ are the solutions required.

It is possible to determine both the film thickness and the substrate complex refractive-index using one measurement of ρ. This is achieved through the use of the characteristics of the three roots of Eq. (19). This process is numerical in nature, which is a small price to pay to avoid the second measurement.

For the SiO₂—Si film-substrate system, one of the roots has positive real and imaginary parts, which is not physically correct, as the film is changed within a hundred angstroms around the true value of the film thickness. The second has physically correct signs of the real and imaginary parts during that thickness period. The third has physically correct signs also, and changes the sign of the imaginary part within two angstroms above the true value of the film thickness. Accordingly, the algorithm in this case is;

Algorithm 3:
1. For an assumed value of the film thickness d calculate the values of A₁−A₉, B₁−B₆, and C₁−C₆by direct substitution into Eqs. (14), (16) [excluding C₀], (18), (20), and (21) using the only known value of the system parameter N₁, and the measured ellipsometric values of (ψ₁, Δ₁) at the angle of incidence φ₀₁.
2. Calculate the solution set (N₂₁, N₂₂, N₂₃) by direct substitution into Eq. (22).
3. Repeat Steps 1 and 2 every ten angstroms to cover the range of d.
4. Identify the one root that starts with correct physical signs for the refractive index n₂ (positive) and the extinction coefficient k₂ (negative) and switches the sign of k₂.
5. Repeat Step 3 every one angstrom and determine the value of d at which k₂ is closest to zero.
6. Take the average of the d values of two and three angstroms less that the value determined in Step 5. This is the correct value of the film thickness to within one angstrom.
7. Take the average, and then round it off, of the N₂ values corresponding to those of Step 6. This is the correct value of the complex refractive-index of the substrate to three digits.
   3. A. 3. Accuracy

A comprehensive error analysis to study the effect of the input variables on the results obtained is carried out. Random and systematic errors of the ellipsometric angles of 0.001 and 0.01°, respectively, are used to represent experimental errors. Errors of the film thickness and film optical constant are also used.

The three-digit true and correct value of the substrate complex refractive-index is always obtained as 3.85−j0.02. When the numerical algorithm to obtain both the film thickness and substrate complex refractive-index is used, the accuracy is very high. A change of 0.001 Å introduces a measurable difference in the two solutions of N₂. The detailed study is not reported as a JOSA A requirement.

3. B. Two Angles of Incidence

When a second set of measurements are taken at a second angle of incidence, we obtain a second third-degree polynomial in N₂² with corresponding coefficients A₇₇, A₈₈, and A₉₉, respectively, using Eq. (19). From the set of two equations at two angles of incidence, we obtain directly the expression;

$${N}_{2} = \sqrt{\frac{( {A}_{88} - {A}_{8} ) \pm \sqrt{{( {A}_{88} - {A}_{8} )}^{2} + 4 ( {A}_{77} - {A}_{7} ) ( {A}_{99} - {A}_{9} )}}{2 ( {A}_{7} - {A}_{77} )}} . \qquad ( 23 )$$

This is a simple closed-form formula to calculate N₂, the complex refractive index of the substrate, from the known system parameters, film thickness d and film complex refractive index N₁, and the measured ellipsometric angles ψ and Δ at two angles of incidence φ₀₁ and φ₀₂.

The algorithm to obtain N₂ is, therefore;

Algorithm 4:
1. Calculate the values of A₁−A₉ and B₁−B₆ by direct substitution into Eqs. (14), (16) [excluding C₀], (18), and (20) using the known values of d, N₁, φ₀₁, ψ₁, and Δ₁, no other parameters are needed. p0 2. Repeat Step. 1 for the second angle of incidence and calculate A₁₁−A₉₉ and B₁₁−B₆₆ using the same known values of d and N₁, and the second set of values of φ₀₂, ψ₀₂, and Δ₂, no other parameters are needed.
3. Calculate N₂ by direct substitution into Eq. (21).
4. Select the solution with physically correct signs of n₂ (positive) and k₂ (negative.)

Note that the four steps of the algorithm are all direct calculations with no iterations involved.

3. C. Three Angles Of Incidence

A similar discussion to that of Sec. 3 with a third angle of incidence in consideration leads to a third equation of the form given in Eq. (19) with coefficients A₇₇₇, A₈₈₈, and A₉₉₉, Eq. (20), and an expression for N₂ in the form,
N₂=(A₉/A₈)(F₂/F₁), (22)
where,

$$\begin{matrix}{F}_{1} = [ ( 1 - \frac{{A}_{99}}{{A}_{9}} ) / ( 1 - \frac{{A}_{77}}{{A}_{7}} ) ] - [ ( 1 - \frac{{A}_{999}}{{A}_{9}} ) / ( 1 - \frac{{A}_{777}}{{A}_{7}} ) ] , & ( 23. a ) \\ {F}_{1} = [ ( 1 - \frac{{A}_{88}}{{A}_{8}} ) / ( 1 - \frac{{A}_{77}}{{A}_{7}} ) ] - [ ( 1 - \frac{{A}_{888}}{{A}_{8}} ) / ( 1 - \frac{{A}_{777}}{{A}_{7}} ) ] . & ( 23. b )\end{matrix}$$

Equation (22) provides a closed-form expression to obtain N₂ from three ellipsometric measurements at three angles of incidence, if needed. It is a first-order equation and gives only one solution. Therefore, it gets rid of the extra solution of Eq. (21). This proves helpful whenever that extra solution is physically correct and a range, or approximate value, for N₂ is not known to choose between the two physically viable solutions.

All discussions of the previous sections hold for this case. Keep in mind that adding a third measurement at a third angle of incidence is done with the experimental errors associated with it.

3. D. Bare Substrate

The bare substrate system is a special case of the film-substrate system, where the film thickness is zero. Therefore, from Eq. (9),

X=1.

And the closed-form inversion of Eq. (19) reduces to;
N₂=N₀⁶ tan² φ₀(ρ²+1+2ρ cos 2φ₀)/(ρ+1)². (24)
Here, as before, we spare the reader simple and direct, but involving, algebraic manipulations. As above, the closed form of Eq. (24) is algebraically accurate.
4. Applications

In this section we discuss two applications of the suggested closed-form inversion for N₂. One is in ellipsometry and the other is in the design of reflection-type optical devices.

4. A. Ellipsometry

Experimentally, the ellipsometric angles ψ and Δ are measured for a film-substrate system at a selected angle of incidence φ₀ using an electromagnetic wave source of a specific wavelength. Actual instruments have their own sources of errors, in addition to the operator's errors. With today's highly sophisticated automated systems, the operator's and operating system's errors are virtually eliminated. We are left with the instrument's errors, random and systematic. Random errors are very small in magnitude and are random in sign, added or subtracted. Therefore, we consider a value of 0.001° in the measured angles φ₀, ψ, and Δ. The analysis of the previous section on the error effects on the obtained values of N₂clearly shows that the random experimental errors have no effect on the accuracy of the results.

The experimental systematic error(s) introduced by today's sophisticated automated systems of ellipsometers are very small, less than 0.01°, and are not random in sign. Therefore, we carried out the error analysis in the previous section to study the effect of a 0.01° error of the three measured ellipsometric angles on the results obtained. And, we considered the error to be of the same sign when applied to any two measured angles; systematic. From the analysis of the previous section, it is clear that the systematic errors have a negligible effect on the accuracy of the results.

It is evident that the three-digit result for N₂ is exact, 3.85−j0.02, for all angles of incidence with the presence of random or systematic experimental errors. And as we mentioned previously, the closed-form formula of Eq. (21) does not produce an error itself.

4. A. 1. Ellipsometry at Two Angles of Incidence

Ellipsometric measurements are usually taken at two angles of incidence, at which the two ellipsometric angles ψ and Δ are measured for a specific film-substrate system. The closed-form expression is then used to obtain the unknown system parameter N₂. The error analysis of the previous section was carried out for this case, and proved the high accuracy of the closed form.

4. A. 2. Ellipsometry at Two Film-Thicknesses

In this case, the ellipsometric measurements are carried out on two film-substrate systems having the same substrate material and the same film material at two different film thicknesses. The closed-form expression of Eq. (21) is also valid for this case. Again, it does not introduce errors of its own, and it tolerates experimental errors very well.

4. A. 3. Ellipsometry at Two Film-Materials

In this case, the ellipsometric measurements are carried out on two film-substrate systems having the same substrate material and the same film thickness of two different film materials. Also, in this case, the closed-form expression of Eq. (21) is valid. And as always, it does not introduce errors of its own, and it tolerates experimental errors very well.

4. B. Design of Reflection-Type Optical Devices

The closed-form expression for N₂ given in Eq. (21) is as useful in the design of reflection-type optical devices as it is in ellipsometry. For example, if we would like to design a film-substrate system that has two specified values of the ellipsometric function ρ at two different angles of incidence, Eq. (21) provides the value of the optical constant of the substrate that satisfies this condition knowing the other system parameters, d and N₁. This is valid if the two values of ρ are for the same system, at two different angles of incidence, at two different film thicknesses, or at two different film materials. These cases parallel those of ellipsometry discussed in Sec. 5.1.

Consider, for example, the case where we would like to find the substrate refractive index to design a reflection device that operates in air at a wavelength of 6328 Å using a SiO₂ film of an arbitrary thickness of 6582 Å, just any film thickness. That device is required to provide relative phase shifts of −180° and 97.8926°, and relative amplitude attenuations of 64.1974° and 45°, at angles of incidence of 56.041° and 65.105°, respectively. Such requirements, or any others, might be for beam compensation purposes in optical systems, say. When that information is fed to a computer program implementing the same algorithm as that described in Sec. 3, one obtains N₂=3.8500−j0.0200 and N₂=0.7267+j0.0010. The second solution is rejected on physical grounds; positive imaginary component.

The above discussed design procedure is applicable to any film-substrate system at any wavelength. It's also valid at one or more angles of incidence, using the corresponding formula.

5. Experimental

Here we present some experimental measurements and the use of the closed-form inversion formula of Eq. (21) to obtain N₂. A Gaertner research ellipsometer, L119X, was used to measure ψ and Δ on a commercially available SiO₂—Si wafer of a nominal film thickness of 10000 Å. A He—Ne laser source was used, with a wavelength of 6328 Å. Measurements were carried out at two angles of incidence of φ₀₁=44.82 and φ₀₂=53.06°. The obtained ψ and Δ are 44.98 and −151.840 at φ₀₁, and 45.02 and 134.41° at φ₀₂, respectively.

When the film thickness of 11376 Å, N₀ of 1 (air ambient), and N₁ of 1.46 are substituted into Eq. (21), N₂=3.8498−j0.0202 is obtained. As a three-digit value N₂=3.85−j0.02, which is the true correct value. This is a very accurate result for N₂. Use of either of the first three algorithms give that result at one or two angles of incidences, respectively.

6. Conclusions

In this communication, we presented a closed-form inversion expression to obtain the complex refractive index N₂ of a film-substrate system using one, two, or three measured values of the two ellipsometric angles ψ and Δ at one, two, or three angles of incidence φ₀. From a single measurement-set at one angle of incidence, 1) N₂is obtained knowing the film complex refractive-index N₁ and film thickness d, by direct substitution, 2) N₁₂ and dare obtained knowing only the film complex refractive-index, by repeated direct-substitution. The same is achieved with two and three measurement-sets.

The closed-form inversion expressions are accurate in themselves and very fast (direct substitution), where a solution always exists (no divergence), no false or local minima encountered, is always stable, no prior knowledge of the solution (starting value) is required, no parameter range is needed, no function to minimize, no curve fitting techniques needed, and it provides for real-time applications.

The results of an input-error analysis are presented that proves the very high accuracy of the closed-form formulae given. It is worth noting that the formulae do not produce errors of their own, and that they very well tolerate errors of the known parameters used. A discussion of using the formulae in ellipsometry applications and in the design of reflection-type optical devices is presented. Also, experimental measurements on a commercial SiO2-Si wafer and the obtained value of N₂ are presented, which proved to be highly accurate.

What is claimed is:

1. A closed-form formula and algorithms to determine the optical constant, complex refractive-index, of the substrate and film thickness of absorbing-film-absorbing-substrate systems in absorbing mediums that is algebraically derived.

2. A computer program to calculate the optical constant, complex refractive-index, of the substrate and film thickness of said systems and perform ellipsometric analysis based on the closed-form formula.

3. A real-time instrument that can be attached to ellipsometers, for calculating the optical constant, complex refractive-index, of the substrate and film thickness of absorbing-film-absorbing-substrate systems in absorbing mediums and perform ellipsometric analysis based on the closed-form formula.
